(19) United States
(12) Patent Application Publication
(10) Pub. No.: US 2016/0180821 A1
(43) Pub. Date: Jun. 23, 2016

(54) DISTRIBUTED MEMORY PANEL

(71) Applicant: Intel Corporation, Santa Clara, CA (US)

(72) Inventors: Peter L. Chang, Portland, OR (US); Kunjal Parikh, San Jose, CA (US); Kumaran Natarajan, Bangalore (IN); Prakash K. Radhakrishnan, Portland, OR (US)

(73) Assignee: INTEL CORPORATION, Santa Clara, CA (US)

(21) Appl. No.: 14/866,629

(22) Filed: Sep. 25, 2015

(30) Foreign Application Priority Data
Dec. 23, 2014 (IN) 6512CHE2014

(51) Int. Cl. G09G 5/36; G06T 1/60

(52) U.S. Cl. CPC G09G 5/363; G06T 1/60

(57) ABSTRACT

A distributed memory panel including a panel, a light emitter of a pixel on the panel, and integrated circuit on the panel. The integrated circuit to include a memory wherein the memory is exclusively associated with the light emitter and a driver to drive the light emitter of the pixel.

### CROSS-REFERENCE TO RELATED APPLICATION

This application claims the benefit of India Patent Application No. 6512CHE2014 filed Dec. 23, 2014.

### TECHNICAL FIELD

This disclosure relates generally to image display on a panel. More specifically, the disclosure relates to improving the energy and computational efficiency of panels to display an image.

### BACKGROUND ART

A display panel is the primary interface on computing systems. Display panel power has two primary energy-demanding tasks: the illumination of the display panel itself and the control accomplished by panel electronics where input data from a data source is re-timed to meet display panel requirements and where this data is then sent to a driver integrated circuit that is used to drive individual display cells on the panel.

### BRIEF DESCRIPTION OF THE DRAWINGS

The following detailed description may be better understood by referencing the accompanying drawings, which contain specific examples of numerous features of the disclosed subject matter.

FIG. 1 is a diagram illustrating an example of a computing device 100 to implement the distributed memory panel techniques discussed herein;

FIG. 2 is a simplified block diagram of an example of a distributed memory panel with an analog signal converter;

FIG. 3 is a simplified block diagram of an example system for implementing a distributed memory panel;

FIG. 4 is a process flow diagram of a method for implementing a distributed memory panel;

FIG. 5 is a block diagram illustrating one example configuration including a plurality of integrated circuits on a distributed memory panel;

FIG. 6 is a block diagram illustrating one example configuration of an integrated circuit serving multiple light emitters on multiple rows;

FIG. 7 is a block diagram illustrating one example timing diagram for analog driving during a scan phase;

FIG. 8 is a block diagram illustrating one example timing diagram for analog driving during an emission phase;

FIG. 9 is a block diagram illustrating one example timing diagram for serial digital driving during a scan phase;

FIG. 10 is a block diagram illustrating one example timing diagram for parallel digital driving during a scan phase;

FIG. 11 is a block diagram illustrating one example timing diagram for digital micro light emitting diode, pulse-width modulation driving for both serial and parallel digital data methods; and

FIG. 12 is a block diagram illustrating an example of a tangible, machine-readable medium for implementing a distributed memory panel.

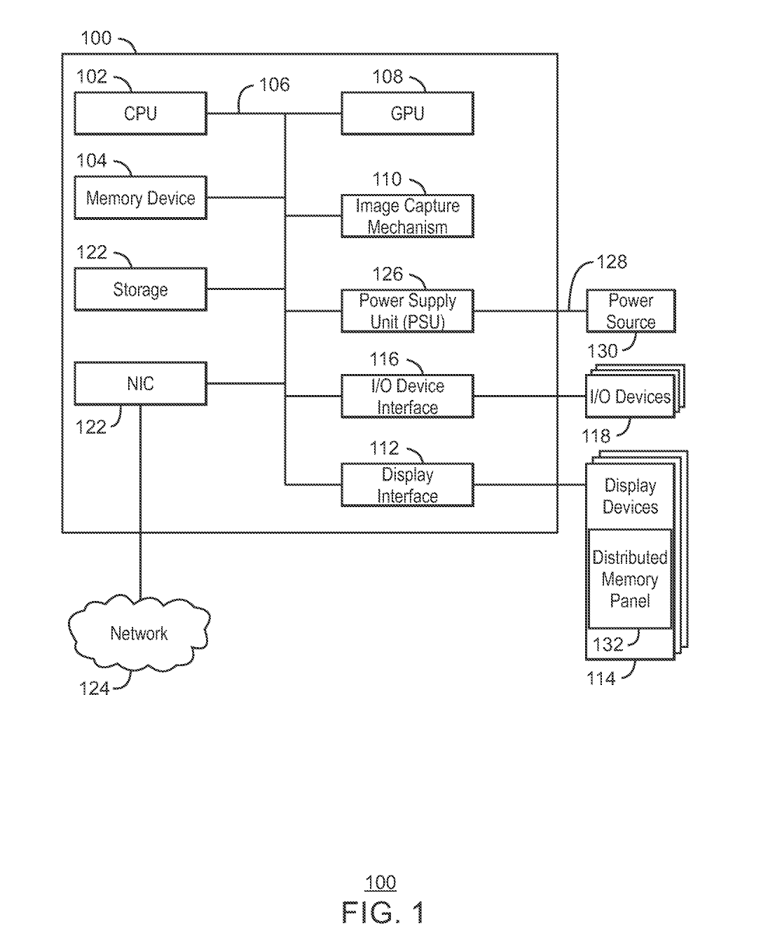

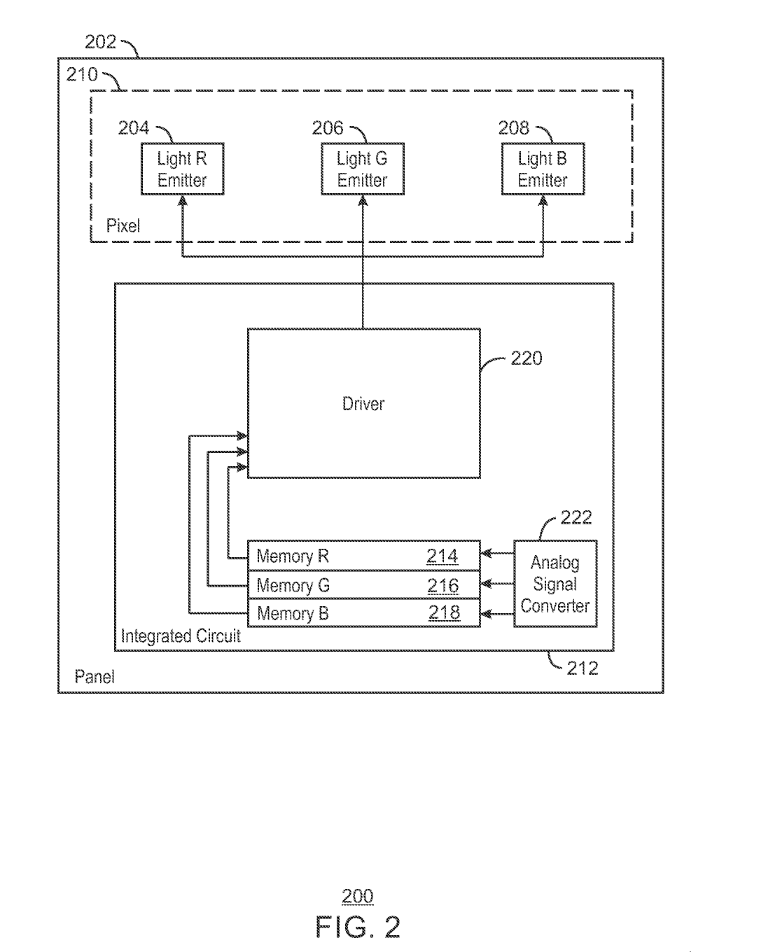

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Display technology has previously incorporated analog backplane that by nature needs constant refreshing, at roughly the frequency of 60 Hz, when displaying data on a screen even when the image displayed is a static image. Display panels that are primarily analog in nature, for example, have used thin film transistors in conjunction with passive storage elements like capacitors to store display image grayscale data. These storage methods involve inherent leakage from capacitors and accordingly the data stored in the panel needs to be refreshed periodically even for a static image.

New manufacturing technologies like micro pick and bond (MPB) facilitate both the mass transfer of micron sized individual non-similar components which may be obtained from different substrates and also the installation of these components onto a final substrate which may be glass or flex. The present disclosure involves, in part, creating a digital version of storage on the panel where the storage is distributed to each pixel or lighting element. In contrast with previous methods, the ability to generate digital storage on the panel itself, in some cases with CMOS storage elements, enables several techniques herein disclosed.

In some examples, a power saving mode may be used for static image by Panel Self Refresh (PSR) in Embedded DisplayPort (eDP) which may put a timing controller, transmitter for panel electronics, and a panel receiver into a low power mode if there is no need to refresh data for a static image or partially static image for a number of static pixels.

In some examples, digital data which is stored in a memory element may be used to drive a Digital to Analog (D2A) converter or a Pulse Width Modulator (PWM) or a Pulse Density Modulator (PDM) which may in turn drive a light emitter such as an organic light emitting diode or an in-organic light emitting diode.

In some examples, the data for an image is stored digitally in a storage element such as a Static Random-Access Memory (SRAM), a Latch, or a FlipFlop. In some examples where the data is stored digitally on the panel, any potential static image may have a regular refresh rate, for example 60 Hz, that is no longer needed as digitally stored data does not leak or degrade in the same way as analog storage can. Accordingly, in some examples, a significant part of the Panel electronics can be shut down when the panel stores data digitally, which in turn facilitates significant power savings.

In some examples, a method may be used to drive the data digitally from a driver integrated circuit of the panel electronics units and store the data in the memory element where either serial or parallel methods are possible. In some examples, a counter based digital circuit may also be included in the integrated circuit to converts the digital grayscale code into pulse width modulation (PWM) signal whose ‘on time’ vs ‘off time’ is based on the grayscale code input. In one example of this modulation, when a grayscale signal is 0 then the signal is always in an off state for a given time window. Likewise, when a grayscale signal is 255 the signal will be ON for the whole time window. Driving data with this method may invoke clocking but may also avoid multiple digital to analog (D2A) and analog to digital (A2D) conversions that may otherwise happen before the data finally reaches its intended lighting emitter element.

In some examples, a common integrated circuit may be used for multiple pixels, lighting emitters, and even rows of pixels. This may allow for a reduction in the number of integrated circuits and memory required to be manufactured onto the display panels. Further, the number of analog to digital (A2D) converters may be reduced as several light emitters or pixels may share an A2D converter.

Distributed storage on a per pixel basis on the panel also may help save saving power during partial screen updates. In one example a small video may be playing and updating pixels and lighting emitters only in memory elements at pixels where the video is playing, while the majority of screen and panel electronics components are turned off or placed in a low-power mode.

The integrated circuit may consist of one common Analog to Digital (A2D) Converter which may be Time Division Multiplexed between the three analog grayscale color data inputs for a given pixel (Red+Green+Blue). The A2D conversion could be handled with four bits all the way up to twelve bits based on a number of factors including area, complexity, or other similar concerns. However, in some examples, the larger the bit width, the more accurate the A2D conversion may be. The converted values for each pixel's light emitters may be stored digitally in their respective memory banks. In some examples, the subsequent Digital to Analog conversion may occur for each light emitter color individually allowing each LED/LCDs to be individually driven by a driver located on the integrated circuit.

Once a value is stored in the integrated circuit, there may be no need for a periodic refresh of the data since the data may be stored in a digital memory. In some examples, in order to avoid the multiple conversions between digital and analog, which each have the potential to add error and lose accuracy, the data may be driven digitally from the Driver integrated circuit (IC), either in serial or parallel with regards to a clock, to the integrated circuit. In some examples, once digital values for an image are latched upon by the integrated circuit, they may be stored in a digital memory element and may be driven to the light emitters by a Pulse Width Modulation (PWM) method. For some examples, PWM may drive light emitters using, in part, the amount of time the signal is on vs the time it's off based on each light emitter's grayscale value stored in the memory element. In some examples, hybrid modes like the following are also feasible. Analog acquisition (A2D on pixel integrated circuits) and LED driving digitally through PWM may be used. Further, digital acquisition on pixel integrated circuits and LED driving through D2A may also be used in some examples.

FIG. 1 is a diagram illustrating an example of a computing device 100 to implement the distributed memory panel techniques discussed herein. The computing device 100 may be, for example, a laptop computer, desktop computer, ultrabook, tablet computer, mobile device, or server, among others. The computing device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the computing device 100 may include more than one CPU 102.

The computing device 100 may also include a graphics processing unit (GPU) 108. As shown, the CPU 102 may be coupled through the bus 106 to the GPU 108. The GPU 108 may be configured to perform any number of graphics functions and actions within the computing device 100. For example, the GPU 108 may be configured to render or manipulate graphics images, graphics frames, videos, or the like, to be displayed to a user of the computing device 100.

The memory device 104 can include random access memory (RAM), read only memory (ROM), flash memory, or any other suitable memory systems. For example, the memory device 104 may include dynamic random access memory (DRAM). The computing device 100 includes an image capture mechanism 110. In some examples, the image capture mechanism 110 is a camera, stereoscopic camera, scanner, infrared sensor, or the like.

The CPU 102 may be linked through the bus 106 to a display interface 112 configured to connect the computing device 100 to one or more display devices 114. The display device(s) 114 may include a display screen that is a built-in component of the computing device 100. Examples of such a computing device include mobile computing devices, such as cell phones, tablets, 2-in-1 computers, notebook computers or the like. The display devices 114 may also include a computer monitor, television, or projector, among others, that is externally connected to the computing device 100. In some cases, the display devices 114 may be head-mounted display devices having a display capacity via projection, digital display, filtering incoming light, and the like.

The CPU 102 may also be connected through the bus 106 to an input/output (I/O) device interface 116 configured to connect the computing device 100 to one or more I/O devices 118. The I/O devices 118 may include, for example, a keyboard and a pointing device, wherein the pointing device may include a touchpad or a touchscreen, among others. The I/O devices 118 may be built-in components of the computing device 100, or may be devices that are externally connected to the computing device 100. In some cases, the I/O devices 118 are touchscreen devices integrated within a display device, such as one or more of the display devices 114.

The computing device 100 may also include a storage device 120. The storage device 120 is a physical memory such as a hard drive, an optical drive, a thumbdrive, an array of drives, or any combinations thereof. The storage device 120 may also include remote storage drives. The computing device 100 may also include a network interface controller (NIC) 122 may be configured to connect the computing device 100 through the bus 106 to a network 124. The network 124 may be a wide area network (WAN), local area network (LAN), or the Internet, among others.

The computing device 100 and each of its components may be powered by a power supply unit (PSU) 126. The CPU 102 may be coupled to the PSU through the bus 106 which may communicate control signals or status signals between then CPU 102 and the PSU 126. The PSU 126 is further coupled through a power source connector 128 to a power source 130. The power source 130 provides electrical current to the PSU 126 through the power source connector 128. A power source connector can include conducting wires, plates or any other means of transmitting power from a power source to the PSU.

The computing device 100 may also include a distributed memory panel 132 located on the display devices 114 to distribute memory on a panel. In some examples, the distributed memory panel 132 may store image data to be displayed so that the computing device 100 does store them in a storage 122 or a memory device 104.

The block diagram of FIG. 1 is not intended to indicate that the computing device 100 is to include all of the components shown in FIG. 1. Further, the computing device 100 may include any number of additional components not shown in FIG. 1, depending on the details of the specific implementation.

FIG. 2 is a simplified block diagram of an example of a distributed memory panel 200 with an analog signal converter. Like numbered features are as described in FIG. 1. The panel 202 may be used to display an image, picture, or other visual data. In some embodiments, the panel is a display of a computer device such as a computer screen or the display screen of a mobile phone.

The panel 202 may display an image through the use of light emitters including light emitter R 204, light emitter G 206, and light emitter B 208. In this figure each light emitter may represent a particular emitted color, such as light emitter R 204 emitting red light. However, the letter designations are for convenience, and it is understood that any color of light may be emitted by particular light emitter R 204, light emitter G 206, or light emitter B 208. Further, while each light emitter 204, 206, and 208 may be a light emitting diode (LED), other light emitting sources may be used as light emitters 204, 206, 208 including liquid-crystal display technology, plasma light emitting sources, organic light-emitting diodes (OLEDs), in-organic light-emitting diodes or micro-LEDs, and any other suitable light emitting sources. These light emitters 204, 206, 208 may each emit a different color at a different level, strength, or intensity such that as a group of light emitters, the number of light emitters 204, 206, 208 form a pixel 210. The pixel 210 may be any picture element that can be manipulated by a controller processing image data. In some examples, the pixel 210 may include three light emitters 204, 206, 208 each of a different color between R, G, and B. A pixel 210 is not limited or required to have three light emitters as some examples include light emitters for red, green, blue, and white light, while other pixels 210 may have other configurations and colors emitted. As used herein, Pixel 210 may refer generally to the smallest addressable element in an all points addressable display device 114. In some examples, a pixel may be the smallest controllable element of a picture represented on the panel 202.

The panel 202 disclosed is not limited to light emitters 204, 206, and 208 but may also include an integrated circuit 212. The integrated circuit 212 may be made of silicon and installed to a screen substrate such as glass of flex using manufacturing technologies such as micro pick and bond (MPB). These techniques may facilitate mass transfer of micron sized individual non-similar components which may be obtained from different substrates and install them on to a final substrate which may be glass or flex. The integrated circuit 212 may be associated with and used in conjunction with each light emitter 204, 206, and 208. In some examples, the integrated circuit 212 may include a memory R 214, a memory G 216, and a memory B 218. Although in FIG. 2 these memory elements are shown as separate elements, each memory 214, 216, and 218 may be part of a single addressable logical space, or may be separate addressable spaces for storage of data. Each memory R 214 may be exclusively associated with storing data for a light emitter R 204. Similarly, each memory G 216 may be exclusively associated with storing data for a light emitter G, and each memory B 218 may be exclusively associated with light emitter 208. In some examples each memory 214, 216, and 218 may be used to store digital data for the light emitters 204, 206, and 208 on to a set of Complementary Metal-Oxide-Semiconductor (CMOS) digital storage elements. CMOS digital storage elements may include a FlipFlop, a Latch, Static Random-Access Memorys (SRAMs), or any other storage element based on CMOS technology. Memory 214, 216, and 218 may also store data exclusively for a light emitter 2014, 206, or 208 based on a number value for that color that is stored in data block sizes including 4, 6, 8, 10, 12, or any other suitable number of bits per color.

The integrated circuit 212 on the panel 202 may also include a driver 220. The driver 220 on the integrated circuit 212 of the panel 202 may convert the digital values each associated with a light emitter intensity. The driver may convert these values stored in a memory 214 to an analog signal and send this signal to a light emitter 204 that may emit light at a particular level or intensity based on this signal. In some examples, digital values for each light emitter 204, 206, and 208 are driven by the driver 220 to each light emitter 204, 206, and 208 by a Pulse Width Modulation (PWM) method where the amount of time the an analog signal is On Vs the time an analog signal is Off is based on a grayscale value for a particular light emitter 204, 206, or 208 stored in a memory 214, 216, or 218.

Further, these values stored in each memory 214, 216, and 218 may originally be obtained from an analog signal converter 222. The analog signal converter 222 may receive analog data or signal for an image and may convert the analog data signal to digital so that it may be stored in a memory 214, 216, or 218.

One example of a benefit of this panel 202 is that in contrast with panels with analog backplanes, the presently disclosed panel 202 does not need constant refreshing when displaying a static image or partially static image. Previous analog backplanes stored values for each light emitter off-panel, and through analog means including storage in capacitors that were prone to leakage. In such systems, an analog signal would need to be repeatedly driven to the same capacitor at 60 Hz or other frequencies in order to maintain the display image even for static images. The presently disclosed panel 202 shows that a value for each light emitter 204, 206, 208 may be stored digitally in a memory 214, 216, 218 in an integrated circuit 212 on the panel 202. In some examples, once a value is stored digitally in a memory 214, 216, or 218 the panel 202 will not need to receive any signal for a particular light emitter 204, 206, or 210 unless the light intensity is to change.

In some examples, when a panel 202 is displaying a static image or a partially static image, any light emitter 204, 206, or 208 that is displaying a static portion of the image may continue to receive the same value from the integrated circuit 212 and a new signal may not be transmitted to the integrated circuit 212 for any memory 214, 216, 218 unless that memory 214, 216, or 218 is associated with a light emitter 204, 206, 208. Accordingly, energy may be saved as fewer signal transmissions may be needed especially when static images are commonly viewed on a distributed memory panel.

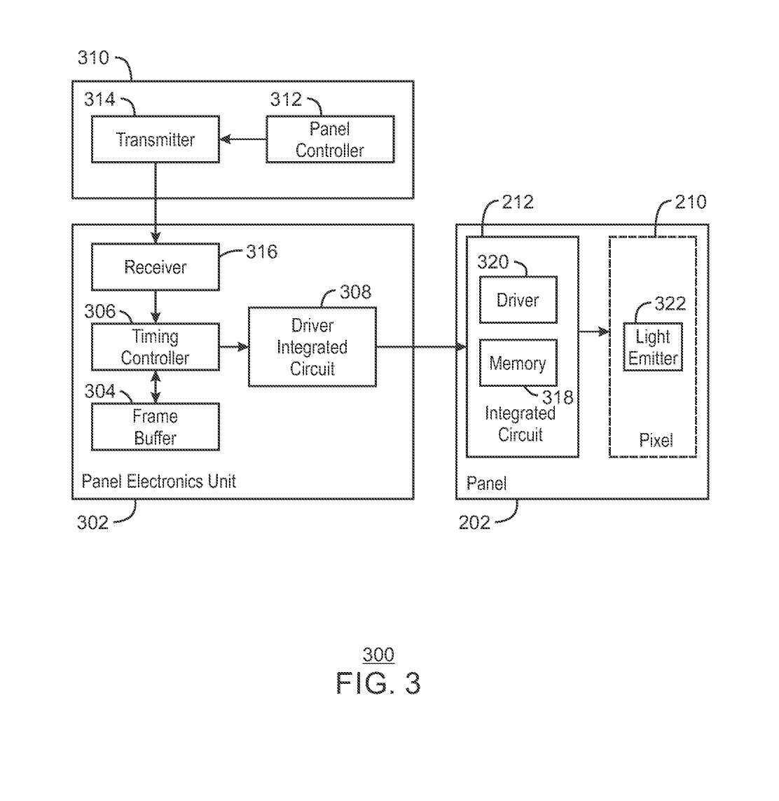

FIG. 3 is a simplified block diagram of an example system 300 for implementing a distributed memory panel. Like numbered features are as described in FIG. 2. The system 300 may include a panel electronics unit 302 to include panel electronics. The panel electronics may include a frame buffer 304, a timing controller, and a driver integrated circuit 308. The frame buffer 304 may store a frame of an image to be displayed. The timing controller 306 may generate horizontal and vertical timing panel signals based on its reading of a frame of an image stored in the frame buffer 304. The driver integrated circuit 308 may transmit an analog signal corresponding to the frame of an image stored in a frame buffer 304 based on the signals provided by the timing controller 306.

The system 300 may include a computer 310 such as a system on a chip or the computing device 100 discussed above. A system on a chip may be an integrated circuit that integrates all components of a computing device 100 or other electronic system into a single chip. A system on a chip may contain digital, analog, mixed-signal, and often radio-frequency functions—all on a single chip substrate. The computer 310 may contain a digital image, video, or other visible element to display on a panel 202. The computer 310 may direct the entire image or simply a single frame to be displayed on a panel 202 with a panel controller 312. The panel controller 312 may include instructing a transmitter 314 to transmit an image, or a frame of an image, to the panel electronics unit 302. The transmitter 314 may transmit the frame of an image using a digital or analog transmission including analog front-end transmission, embedded display port, or transmission according to MIPI specification. The frame of an image may be received by a receiver 316. The receiver 316 may then pass the signal of the frame of the image to the trimming controller 306. Depending on the signal received, the timing controller 306 may determine that the frame should be stored in the frame buffer until it's time to be shown on the panel 202. The timing controller 306 may also determine that a frame or the signal for a frame should be sent immediately to the panel 202. In these cases, the timing controller 306 may send the signals for the frame to the driver integrated circuit 308 to send to the panel 202.

If a driver integrated circuit 308 transmits the horizontal and vertical timing signals for a frame of an image to the integrated circuit 212. The integrated circuit may store pixel 210 specific data in a memory 318. The memory 318 may store the data digitally and may not need refreshing of the data or signal unless the image is updated for a particular pixel 210. The integrated circuit 212 may also include a driver 320 to drive the values stored in the memory 318 to the pixel 210. The driving of the data with the driver 320 may take place via a digital to analog signal conversion to send an analog signal to a light emitter 322 of the pixel 210. The driving of the data with the driver 320 may also take place when the integrated circuit 212 includes a counter based digital circuit to convert data received from a driver integrated circuit 308 into a pulse width modulation signal. In some examples, the driver 320 may drive the light emitter 322 of the pixel 210 based on the pulse width modulation signal.

In some examples, the memory 318 stores data associated exclusively with a particular pixel 210 or a particular light emitter 322. In those cases the driver integrated circuit 308 need not transmit any data or signal for that particular light emitter 322 or pixel 210 unless the image to be displayed on a panel 202 changes the values for that particular light emitter 322 or pixel 210. Accordingly, if a static image is being displayed, the driver integrated circuit 308 may stop functioning at least momentarily and may also stop drawing power. In the case where only a partial static image is being displayed on a panel 202, the driver integrated circuit 308 may only transfer updates or signal regarding pixels 210 that require an update. Similarly, if a static image is being displayed, the frame buffer 304 may not be receiving updated frames of an image and accordingly may stop drawing power until a new image may be displayed on the panel 202. Likewise, the timing controller 306, may not need to refresh an image if the image is partially or completely static. In some examples, the values to be transmitted for the light emitter 322 do not leak as they may be stored digitally in CMOS storage elements in a memory 318 in the integrated circuit 212 on the panel 202. In some examples, the timing controller 306 may reduce functioning or cease functioning completely while a static image is being displayed on the panel 202.

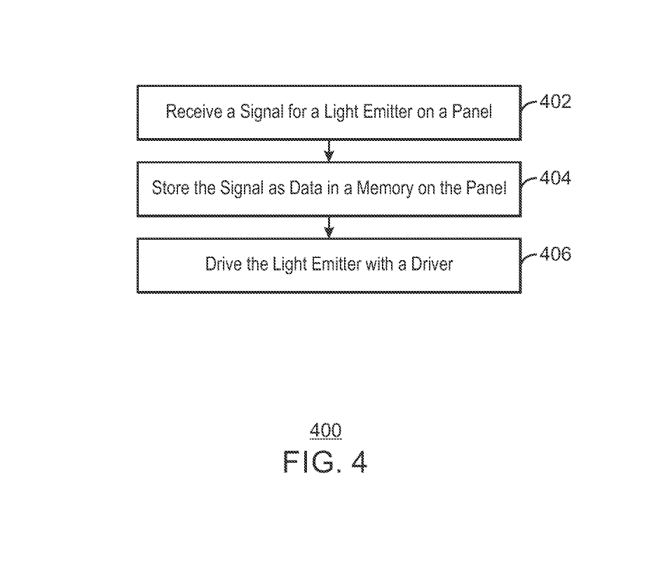

FIG. 4 is a process flow diagram of a method for implementing a distributed memory panel. At block 402, the method begins by receiving a signal for a light emitter 322 on a panel 202. In some examples the signal is received by an integrated circuit 212 wherein the integrated circuit 212 may be located on the panel 202.

At block 404, the signal that was received at block 402 is stored in a memory 318 on the panel 202. In some examples, the memory 318 is located in an integrated circuit 212. The storage of the signal in a memory 316 may be digital storage such that no substantial leakage occurs and such that the panel 202 does not need to receive a signal for a light emitter 322 again until or unless the value for a light emitter 322 changes based on an image to be displayed on the panel 202.

At block 406, a driver 320 drives the light emitter 322 based on the data stored in a memory 316. This driver 320 may be converting the digital data stored in the memory 316 to an analog signal that may affect the light emitter 322.

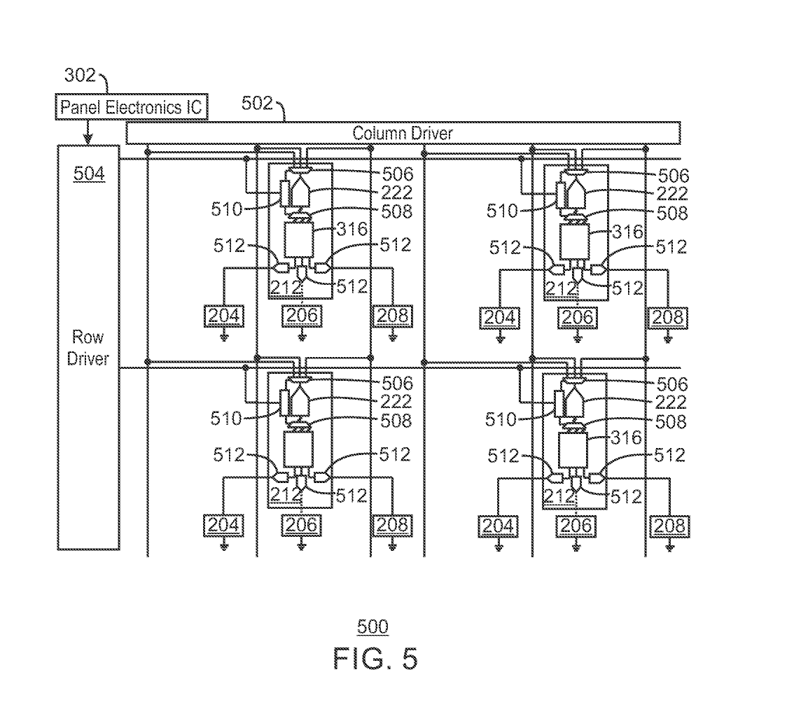

FIG. 5 is a block diagram illustrating one example configuration including a plurality of integrated circuits 500 on a distributed memory panel. Like elements are as described in FIGS. 2 and 3. A column driver 502 and a row driver 504 are shown to highlight the various forms a timing controller 306 may convert frame data to, specifically, horizontal and vertical signals. These signals are driven to the integrated circuit 212 by the column driver 502 and the row driver 504 respectively. The column driver may convert the digital signal to analog to transmit the multiple signals which may include grayscale data for light emitter R 204, light emitter G 206, and light emitter B 208 respectively. Even though these colors are shown by light emitters, other colors and light emitting technology may also be used.

A multiplexer (MUX) 506 may receive the multiple signals from the column driver and may interface with an analog digital converter 222 to convert the analog signals to digital signals so that they may be de-multiplexed at a de-multiplexer (DE-MUX) 508 and stored in memory 316. In some examples, a control 510 may be included in the integrated circuit 212 to receive signal from the row driver 504 and aid the DE-MUX in correctly storing the correct data to the right memory location in the memory 316. A digital to analog (D2A) driver 512 may be included in the integrated circuit 212 to drive the light emitters 204, 206, 208, based on the data stored in a memory 316.

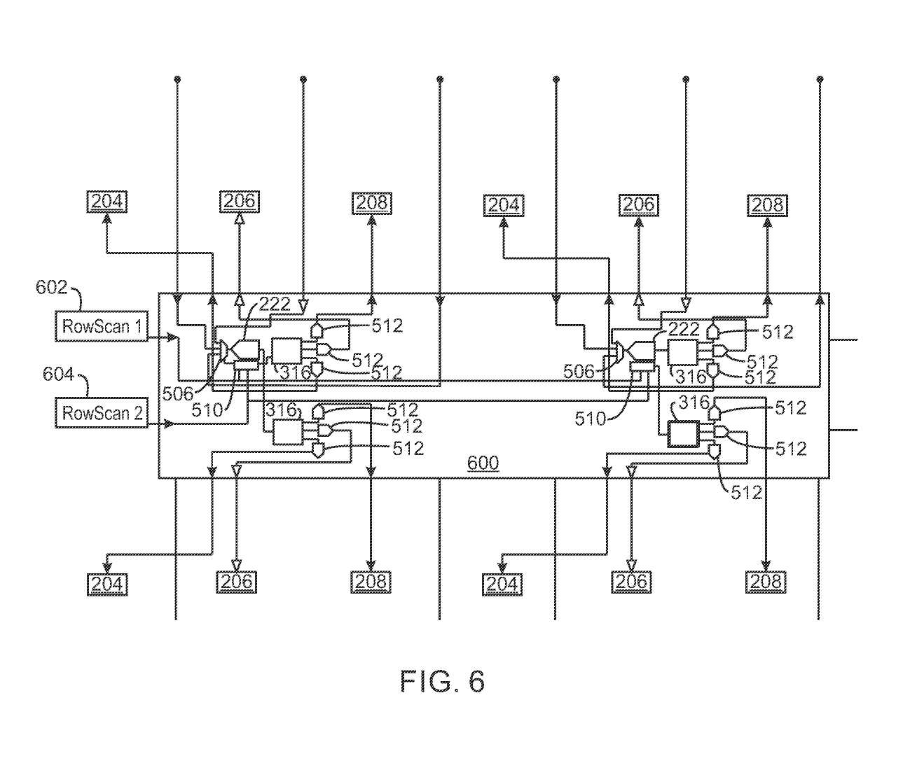

FIG. 6 is a block diagram illustrating one example configuration of an integrated circuit serving multiple light emitters on multiple rows 600. Like elements are as described in FIGS. 2, 3, and 5. A row_scan 1 602 may be used to trigger a scanning step by the multiple controls 510 present in the integrated circuit serving multiple light emitters on multiple rows 600. Similarly, a row_scan 2 604 may be used to trigger a scanning step by the multiple controls 510 present in the integrated circuit serving multiple light emitters on multiple rows 600. The row_scan 1 602 may scan for signal for light emitters 204, 206, 208 on row 1. The row_scan 2 604 may scan for signal for light emitters 204, 206, 208 on row 2. The row_scans 602, 604 share a control for each column to aid in controlling the input signals for each of the light emitters specifically to ensure that the MUX 506 stores each signal correctly the appropriate memory 316 location considering there is only one control and one analog signal converter 222 for multiple light emitters 204, 206, 208 on different rows for different pixels 210. In this way, a second light emitter of a second pixel on the panel may share the control 510 and the analog to digital signal converter 222 where the analog to digital signal converter 222 converts analog signals for both the light emitter for the pixel and the second light emitter for the second pixel. The converted data for each is stored in memory 318.

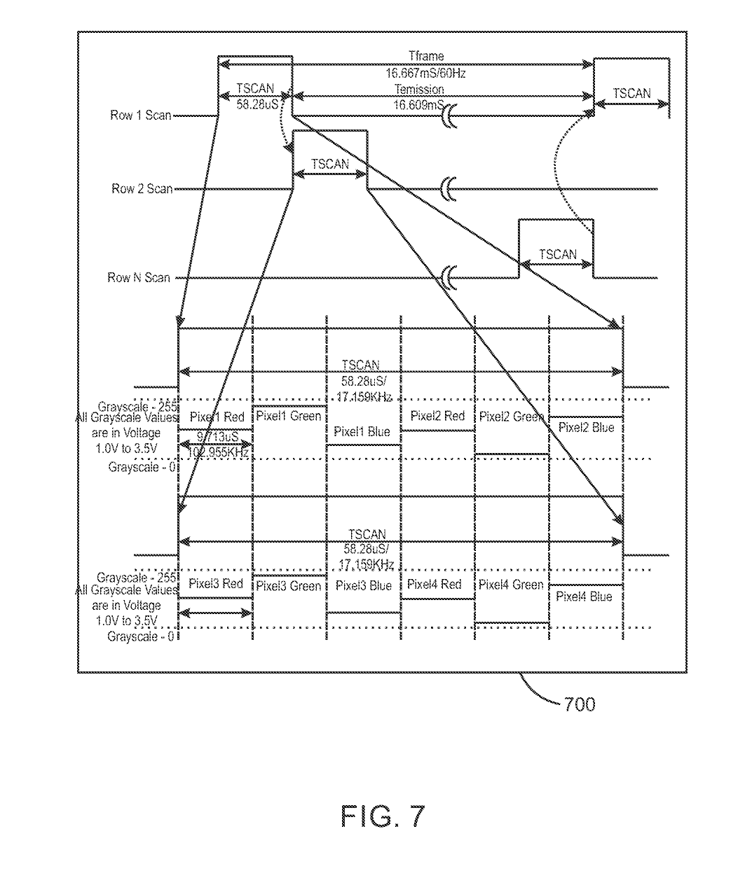

FIG. 7 is a block diagram illustrating one example timing diagram 700 for analog driving during a scan phase. The illustrated timing diagram is just one example of the timing that may be used to convey an analog signal for light emitters 204, 206, 208. All times shown are merely exemplary and should not be understood as limiting. The upper half shows Timing of the scan (Tscan) times for rows 1 and 2 and the lower half shows an enlarged diagram of the grayscale for each exemplary color value for light emitters 204, 206, 208 detected during the Tscan time intervals. This timing diagram 700 is indicative of the analog to digital phase where an integrated circuit 212 may receive analog signal and convert it to digital data to be stored in a memory 318.

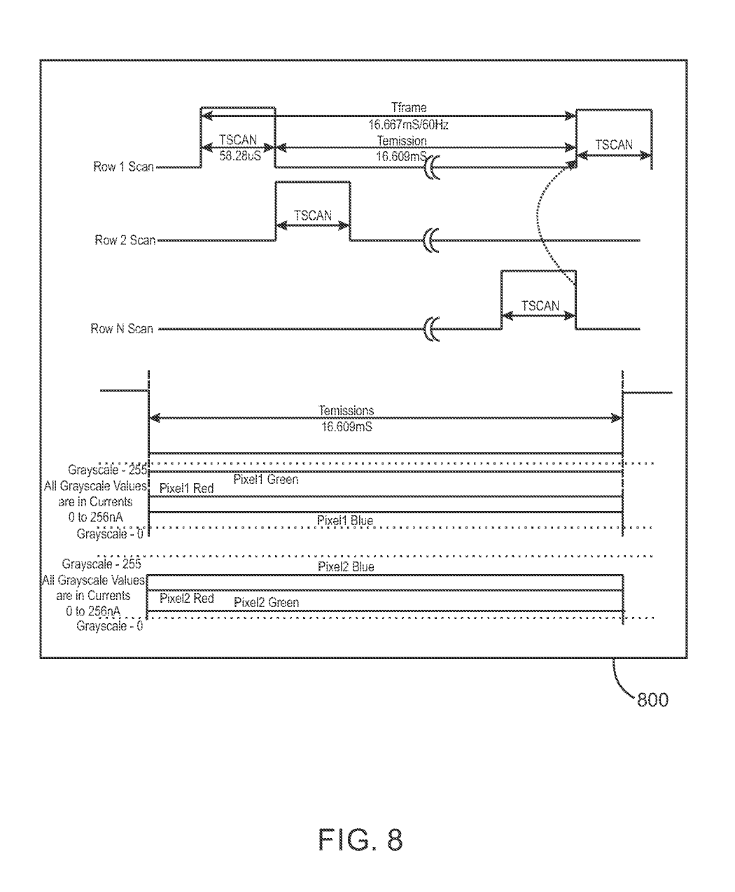

FIG. 8 is a block diagram illustrating one example timing diagram 800 for analog driving during an emission phase. The illustrated timing diagram 800 is just one example of the timing that may be used to drive light emitters 204, 206, 208 based on digital value data stored in memory 318. All times shown are merely exemplary and should not be understood as limiting. The upper half shows timing of the emission phase (Temission) times for rows 1 and 2 and the lower half shows an enlarged diagram of the grayscale values for each exemplary color value for light emitters 204, 206, 208 detected during the Tscan time intervals. This timing diagram 800 is indicative of the digital data being read from a memory 318 to drive the light emitters 204, 206, 208.

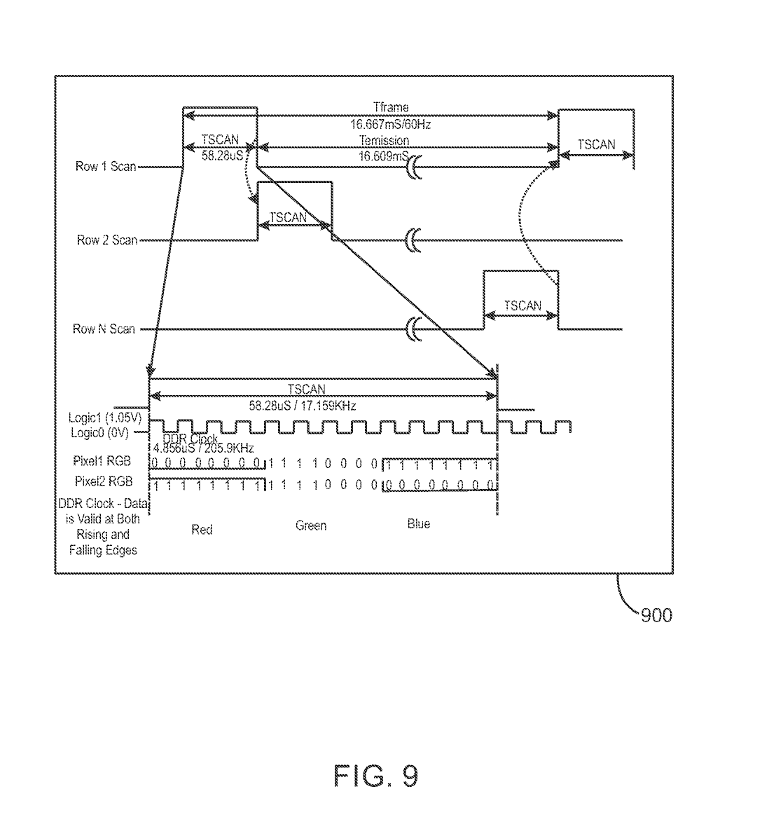

FIG. 9 is a block diagram illustrating one example timing diagram for serial digital driving during a scan phase. The illustrated timing diagram 900 is just one example of the timing that may be used to drive light emitters 204, 206, 208 based on digital value data stored in memory 318. All times shown are merely exemplary and should not be understood as limiting. The upper half of this figure shows timing of the scan phase (Tscan) times for rows 1 and 2 and the lower half of this figure shows an enlarged diagram of the voltage and logic for scanning for pixel values for red, green, and blue data. This diagram makes the assumption that the integrated circuit includes a digital signal receiver and is also driving two pixels. It is understood that additional pixels may also be driven. In this figure, one col line may be used for data, e.g. serial 8 bit for red, green, and blue. Another col line may be used for clock double data rate (DDR) signal where data is valid at both rising and falling edges. For a given row all integrated circuits may be latching data at the same time. This data may be stored in static random access memory (SRAM), or a latch, or a flip flop digital storage element on an integrated circuit.

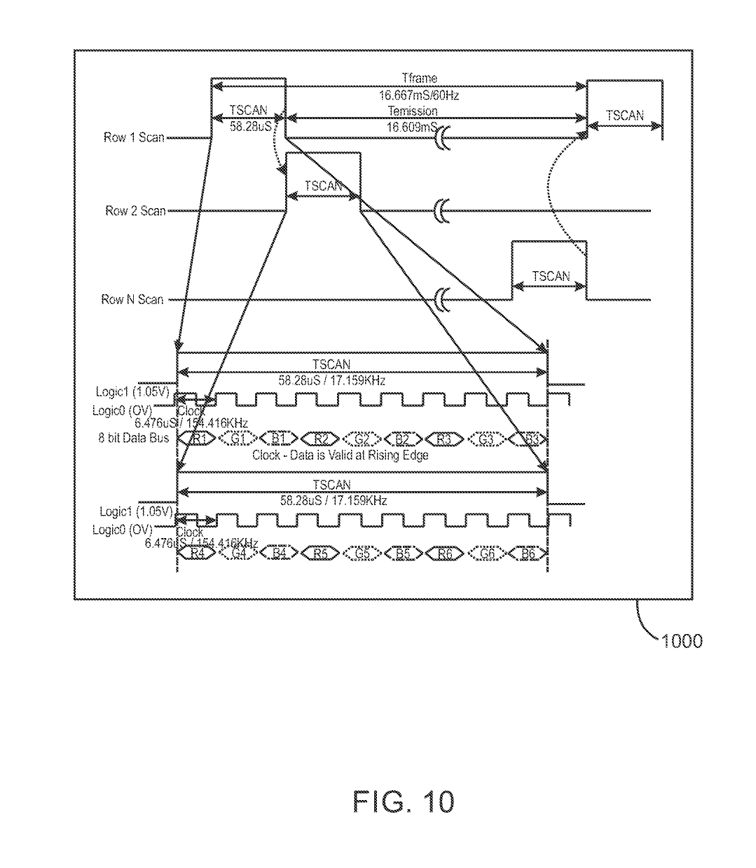

FIG. 10 is a block diagram illustrating one example timing diagram for parallel digital driving during a scan phase. The illustrated timing diagram 1000 is just one example of the timing that may be used to drive light emitters 204, 206, 208 based on digital value data stored in memory 318. All times shown are merely exemplary and should not be understood as limiting. The upper half shows timing of the scanning phase (Tscan) times for rows 1 and 2 and the lower half shows an enlarged diagram of the grayscale values for each exemplary color value for light emitters 204, 206, 208 detected during the Tscan time intervals. This timing diagram 1000 is indicative of the digital data being read from a memory 318 to drive the light emitters 204, 206, 208. This diagram may show an integrated circuit that is driving 3 pixels in parallel. In some examples, 8 col lines may be used for parallel data and another col line for a clock where data is valid at the rising edge. In some examples, for a given row, all integrated circuits may be latching data at the same time. Data may be stored in SRAM, latch, flip flop or other suitable digital storage elements on the integrated circuit 212.

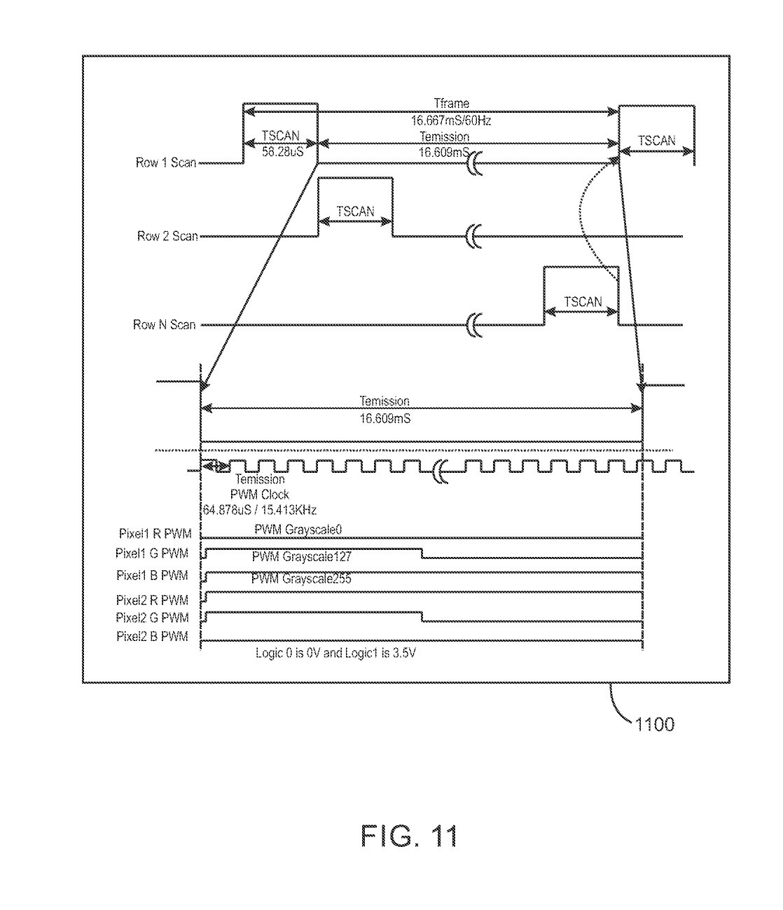

FIG. 11 is a block diagram illustrating one example timing diagram for digital micro light emitting diode, pulse-width modulation driving for both serial and parallel digital data methods. The illustrated timing diagram 1100 is just one example of the timing that may be used to drive light emitters 204, 206, 208 based on digital value data stored in memory 318. All times shown are merely exemplary and should not be understood as limiting. The upper half shows timing of the emission phase (Temission) times for rows 1 and 2 and the lower half shows an enlarged diagram of the pulse-width modulation (PWM) grayscale signals for each exemplary color value for light emitters 204, 206, 208 received during the Tscan time intervals. In this example, all pixels of the same row may be driven simultaneously in parallel with their respective grayscale values. In examples, 3.5 volts may be the supply from which these current sources drive these grayscale values.

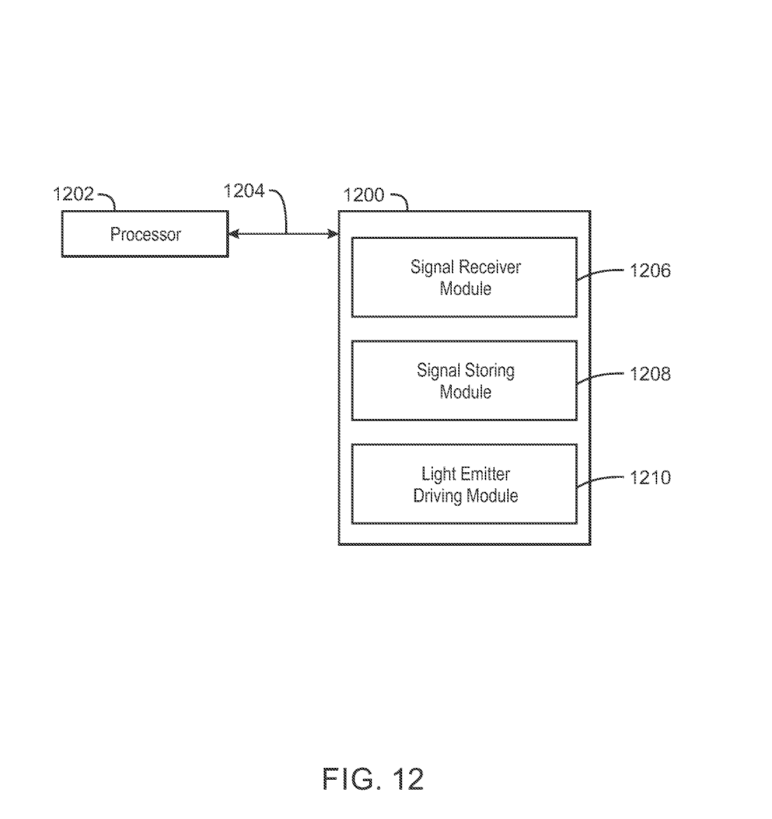

FIG. 12 is a block diagram illustrating an example of a tangible, machine-readable medium 1200 for implementing a distributed memory panel. The machine-readable medium may be connected to a process 1202 by a bus 1204. The processor 1202 may be a single core processor, a multi-core processor, a computing cluster, or any number of other configurations. The bus 1204 may link and allow the transmission of data between the processor 1202 and the machine-readable medium 1200. The machine-readable medium 1200 may be a non-transitory machine-readable medium, a storage device configured to store executable instructions, or any combination thereof. In any case, the machine-readable medium 1200 is not configured as a wave or signal.

The machine-readable medium 1200 may include a signal receiver module 1206, to receive a signal for a light emitter on a panel. The signal receiver module 1206 may also be located as part of an integrated circuit that is also found on the machine-readable medium 1200. The machine-readable medium may also include a signal storing module 1208 to store the signal that is received by the signal receiver module 1206 as data in a memory on the panel. The signal storing module 1208 may only store data for a particular light emitter on the memory associated with that particular light emitter. The machine-readable medium may also include a light emitter driving module 1210. The light emitter driving module 1210 may include the capability to drive the light emitter with a driver based on the data stored in a memory on the panel. In some examples, the light emitter driving module 1210 is located on an integrated circuit that is on the panel.

### EXAMPLES

Example 1 is a distributed memory panel. The distributed memory panel includes a panel; a light emitter of a pixel on the panel; and an integrated circuit on the panel wherein the integrated circuit comprises: a memory wherein the memory is exclusively associated with the light emitter; and a driver to drive the light emitter of the pixel.

Example 2 includes the distributed memory panel of example 1, including or excluding optional features. In this example, the integrated circuit comprises an analog signal converter to receive an analog signal and convert the analog signal to a digital signal to be stored digitally in the memory.

Example 3 includes the distributed memory panel of any one of examples 1 to 2, including or excluding optional features. In this example, the integrated circuit comprises a digital signal receiver to receive a digital signal to be stored digitally in the memory.

Example 4 includes the distributed memory panel of any one of examples 1 to 3, including or excluding optional features. In this example, the memory is a complementary metal-oxide-semiconductor digital storage element.

Example 5 includes the distributed memory panel of any one of examples 1 to 4, including or excluding optional features. In this example, the integrated circuit comprises: a counter based digital circuit to convert received data into a pulse width modulation signal; and wherein the driver is to drive the light emitter of the pixel based on the pulse width modulation signal.

Example 6 includes the distributed memory panel of any one of examples 1 to 5, including or excluding optional features. In this example, the distributed memory panel includes a second light emitter of a second pixel on the panel; and wherein the integrated circuit comprises: an analog signal converter to receive analog signals for both the light emitter and the second light emitter and to convert the analog signals to digital signals to be stored digitally in the memory.

Example 7 includes the distributed memory panel of any one of examples 1 to 6, including or excluding optional features. In this example, the distributed memory panel includes a second light emitter of a second pixel on the panel; and wherein the integrated circuit comprises: a digital signal receiver to receive signals for both the light emitter and the second light emitter to be stored digitally in the memory.

Example 8 is a system for a distributed memory panel. The system includes a panel electronics unit comprising: a frame buffer; a timing controller; a driver integrated circuit; and a panel; a light emitter of a pixel on the panel; and an integrated circuit on the panel wherein the integrated circuit comprises: a memory wherein the memory is exclusively associated with the light emitter; and a driver to drive the light emitter of the pixel.

Example 9 includes the system of example 8, including or excluding optional features. In this example, the integrated circuit comprises an analog signal converter to receive an analog signal from the driver integrated circuit and convert the analog signal to a digital signal to be stored digitally in the memory.

Example 10 includes the system of any one of examples 8 to 9, including or excluding optional features. In this example, the integrated circuit comprises a digital signal receiver to receive a digital signal from the driver integrated circuit to be stored digitally in the memory.

Example 11 includes the system of any one of examples 8 to 10, including or excluding optional features. In this example, the memory is complementary metal-oxide-semiconductor digital storage elements.

Example 12 includes the system of any one of examples 8 to 11, including or excluding optional features. In this example, the integrated circuit comprises: a counter based digital circuit to convert received data into a pulse width modulation signal; and wherein the driver is to drive the light emitter of the pixel based on the pulse width modulation signal.

Example 13 includes the system of any one of examples 8 to 12, including or excluding optional features. In this example, the system includes a second light emitter of a second pixel on the panel; and wherein the integrated circuit comprises: an analog signal converter to receive analog signals from a driver integrated circuit for both the light emitter and the second light emitter and to convert the analog signals to digital signals to be stored digitally in the memory.

Example 14 includes the system of any one of examples 8 to 13, including or excluding optional features. In this example, the system includes a second light emitter of a second pixel on the panel; and wherein the integrated circuit comprises: a digital signal receiver to receive signals from a driver integrated circuit for both the light emitter and the second light emitter to be stored digitally in the memory.

Example 15 includes the system of any one of examples 8 to 14, including or excluding optional features. In this example, the frame buffer stores data for a frame to be displayed on the panel; the timing controller reads the data for the frame from the frame buffer and sends the data for the frame to the driver integrated circuit; the driver integrated circuit drives the data for the frame to the integrated circuit; and at least one of the frame buffer, the timing controller, and the driver integrated circuit stop receiving power until the panel electronics unit receives an instruction to update the data for the frame being driven to the integrated circuit.

Example 16 includes the system of any one of examples 8 to 15, including or excluding optional features. In this example, the frame buffer stores data for the light emitter to be displayed on the panel; the timing controller reads the data for the light emitter from the frame buffer and sends the data for the light emitter to the driver integrated circuit; the driver integrated circuit drives the data for the light emitter to the integrated circuit; and at least one of the frame buffer, the timing controller, and the driver integrated circuit stop receiving power until the panel electronics unit receives an instruction to update the data for the light emitter being driven to the integrated circuit.

Example 17 is a machine-readable medium. The machine-readable medium includes instructions that direct the processor to receive a signal for a light emitter of a pixel with an integrated circuit on a panel; store the signal as data in a memory of the integrated circuit wherein the memory is exclusively associated with the light emitter; drive the light emitter of the pixel with a driver of the integrated circuit based on the data.

Example 18 includes the machine-readable medium of example 17, including or excluding optional features. In this example, the integrated circuit comprises an analog signal converter to convert the signal, if the signal is analog, to a signal that is digital prior to storage as data in the memory.

Example 19 includes the machine-readable medium of any one of examples 17 to 18, including or excluding optional features. In this example, the memory is complementary metal-oxide-semiconductor digital storage elements.

Example 20 includes the machine-readable medium of any one of examples 17 to 19, including or excluding optional features. In this example, the machine-readable medium includes instructions to: convert the signal received into data for pulse width modulation; and wherein the driving of the light emitter is based on the data for pulse width modulation.

Example 21 includes the machine-readable medium of any one of examples 17 to 20, including or excluding optional features. In this example, the integrated circuit comprises a digital signal receiver to receive a digital signal from the driver integrated circuit to be stored digitally in the memory.

Example 22 includes the machine-readable medium of any one of examples 17 to 21, including or excluding optional features. In this example, the integrated circuit comprises: a counter based digital circuit to convert received data into a pulse width modulation signal; and wherein the driver is to drive the light emitter of the pixel based on the pulse width modulation signal.

Example 23 includes the machine-readable medium of any one of examples 17 to 22, including or excluding optional features. In this example, the machine-readable medium includes a second light emitter of a second pixel on the panel; and wherein the integrated circuit comprises: an analog signal converter to receive analog signals from a driver integrated circuit for both the light emitter and the second light emitter and to convert the analog signals to digital signals to be stored digitally in the memory.

Example 24 includes the machine-readable medium of any one of examples 17 to 23, including or excluding optional features. In this example, the machine-readable medium includes a second light emitter of a second pixel on the panel; and wherein the integrated circuit comprises: a digital signal receiver to receive signals from a driver integrated circuit for both the light emitter and the second light emitter to be stored digitally in the memory.

Example 25 includes the machine-readable medium of any one of examples 17 to 24, including or excluding optional features. In this example, the frame buffer stores data for a frame to be displayed on the panel; the timing controller reads.

Example 26 is a method to implement a distributed memory panel. The method includes instructions that direct the processor to receiving a signal for a light emitter of a pixel with an integrated circuit on a panel; storing the signal as data in a memory of the integrated circuit wherein the memory is exclusively associated with the light emitter; driving the light emitter of the pixel with a driver of the integrated circuit based on the data.

Example 27 includes the method of example 26, including or excluding optional features. In this example, the integrated circuit comprises an analog signal converter to convert the signal, if the signal is analog, to a signal that is digital prior to storage as data in the memory.

Example 28 includes the method of any one of examples 26 to 27, including or excluding optional features. In this example, the memory is complementary metal-oxide-semiconductor digital storage elements.

Example 29 includes the method of any one of examples 26 to 28, including or excluding optional features. In this example, the integrated circuit comprises converting the signal received into data for pulse width modulation. Optionally, the driving of the light emitter is based on the data for pulse width modulation.

Example 30 is a distributed memory panel. The distributed memory panel includes instructions that direct the processor to a panel; means for emitting light of a pixel on the panel; and an integrated circuit on the panel wherein the integrated circuit comprises: a memory wherein the memory is exclusively associated with the means for emitting light; and means to drive the means for emitting light of the pixel.

Example 31 includes the distributed memory panel of example 30, including or excluding optional features. In this example, the integrated circuit comprises an analog signal converter to receive an analog signal and convert the analog signal to a digital signal to be stored digitally in the memory.

Example 32 includes the distributed memory panel of any one of examples 30 to 31, including or excluding optional features. In this example, the integrated circuit comprises a digital signal receiver to receive a digital signal to be stored digitally in the memory.

Example 33 includes the distributed memory panel of any one of examples 30 to 32, including or excluding optional features. In this example, the memory is a complementary metal-oxide-semiconductor digital storage element.

Example 34 includes the distributed memory panel of any one of examples 30 to 33, including or excluding optional features. In this example, the integrated circuit comprises a counter based digital circuit to convert received data into a pulse width modulation signal. Optionally, the means to drive is to drive the means for emitting light of the pixel based on the pulse width modulation signal.

Example 35 includes the distributed memory panel of any one of examples 30 to 34, including or excluding optional features. In this example, the distributed memory panel includes a second means for emitting light of a second pixel on the panel. Optionally, the integrated circuit comprises an analog signal converter to receive analog signals for both the means for emitting light and the second means for emitting light and to convert the analog signals to digital signals to be stored digitally in the memory.

Example 36 includes the distributed memory panel of any one of examples 30 to 35, including or excluding optional features. In this example, the integrated circuit comprises a digital signal receiver to receive signals for both the means for emitting light and the second means for emitting light to be stored digitally in the memory.

Example 37 is a method to implement a distributed memory panel. The method includes instructions that direct the processor to receiving a signal for a means for emitting light of a pixel with an integrated circuit on a panel; storing the signal as data in a memory of the integrated circuit wherein the memory is exclusively associated with the means for emitting light; driving the means for emitting light of the pixel with a means to drive of the integrated circuit based on the data.

Example 38 includes the method of example 37, including or excluding optional features. In this example, the integrated circuit comprises an analog signal converter to convert the signal, if the signal is analog, to a signal that is digital prior to storage as data in the memory.

Example 39 includes the method of any one of examples 37 to 38, including or excluding optional features. In this example, the memory is complementary metal-oxide-semiconductor digital storage elements.

Example 40 includes the method of any one of examples 37 to 39, including or excluding optional features. In this example, the integrated circuit comprises converting the signal received into data for pulse width modulation. Optionally, the driving of the means for emitting light is based on the data for pulse width modulation.

Example 41 is a machine-readable medium. The machine-readable medium includes instructions that direct the processor to receive a signal for a means for emitting light of a pixel with an integrated circuit on a panel; store the signal as data in a memory of the integrated circuit wherein the memory is exclusively associated with the means for emitting light; drive the means for emitting light of the pixel with a means to drive of the integrated circuit based on the data.

Example 42 includes the machine-readable medium of example 41, including or excluding optional features. In this example, the integrated circuit comprises an analog signal converter to convert the signal, if the signal is analog, to a signal that is digital prior to storage as data in the memory.

Example 43 includes the machine-readable medium of any one of examples 41 to 42, including or excluding optional features. In this example, the memory is complementary metal-oxide-semiconductor digital storage elements.

Example 44 includes the machine-readable medium of any one of examples 41 to 43, including or excluding optional features. In this example, the machine-readable medium includes instructions to convert the signal received into data for pulse width modulation. Optionally, the driving of the means for emitting light is based on the data for pulse width modulation.

Example 45 includes the machine-readable medium of any one of examples 41 to 44, including or excluding optional features. In this example, the integrated circuit comprises: a counter based digital circuit to convert received data into a pulse width modulation signal; and wherein the driver is to drive the light emitter of the pixel based on the pulse width modulation signal.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any tangible mechanism for storing, transmitting, or receiving information in a form readable by a machine, such as antennas, optical fibers, communication interfaces, etc. Program code may be transmitted in the form of packets, serial data, parallel data, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Not all components, features, structures, characteristics, etc. described and illustrated herein may be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein may not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the machine-readable medium described herein. Furthermore, although flow diagrams and/or state diagrams may have been used herein to describe embodiments, the techniques are not limited to those diagrams or to corresponding descriptions herein. For example, flow may not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result. Further, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any tangible mechanism for storing, transmitting, or receiving information in a form readable by a machine, such as antennas, optical fibers, communication interfaces, etc. Program code may be transmitted in the form of packets, serial data, parallel data, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the functions described herein. A machine-readable medium may include any mechanism for storing or transmitting information in a form readable by a machine, e.g., a computer. For example, a machine-readable medium may include read only memory (ROM), random access memory (RAM), magnetic disk storage media, optical storage media, flash memory devices, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

Although functions may be described as a sequential process, some of the functions may in fact be performed in parallel, concurrently, and/or in a distributed environment, and with program code stored locally and/or remotely for access by single or multi-processor machines. In addition, in some embodiments the order of functions may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. A distributed memory panel comprising:
a panel;
a light emitter of a pixel on the panel; and
an integrated circuit on the panel wherein the integrated circuit comprises:
a memory wherein the memory is exclusively associated with the light emitter; and
a driver to drive the light emitter of the pixel.

2. The distributed memory panel of claim 1, wherein the integrated circuit comprises an analog signal converter to receive an analog signal and convert the analog signal to a digital signal to be stored digitally in the memory.

3. The distributed memory panel of claim 1, wherein the integrated circuit comprises a digital signal receiver to receive a digital signal to be stored digitally in the memory.

4. The distributed memory panel of claim 1, wherein the memory is a complementary metal-oxide-semiconductor digital storage element.

5. The distributed memory panel of claim 1, wherein the integrated circuit comprises:
a counter based digital circuit to convert received data into a pulse width modulation signal; and
wherein the driver is to drive the light emitter of the pixel based on the pulse width modulation signal.

6. The distributed memory panel of claim 1, comprising:
a second light emitter of a second pixel on the panel; and
wherein the integrated circuit comprises:
an analog signal converter to receive analog signals for both the light emitter and the second light emitter and to convert the analog signals to digital signals to be stored digitally in the memory.

7. The distributed memory panel of claim 1, comprising:
a second light emitter of a second pixel on the panel; and
wherein the integrated circuit comprises:
a digital signal receiver to receive signals for both the light emitter and the second light emitter to be stored digitally in the memory.

8. A system for a distributed memory panel comprising:
a panel electronics unit comprising:
a frame buffer;
a timing controller;
a driver integrated circuit; and
a panel;
a light emitter of a pixel on the panel; and
an integrated circuit on the panel wherein the integrated circuit comprises:
a memory wherein the memory is exclusively associated with the light emitter; and
a driver to drive the light emitter of the pixel.

9. The system for a distributed memory panel of claim 8, wherein the integrated circuit comprises an analog signal converter to receive an analog signal from the driver integrated circuit and convert the analog signal to a digital signal to be stored digitally in the memory.

10. The system for a distributed memory panel of claim 8, wherein the integrated circuit comprises a digital signal receiver to receive a digital signal from the driver integrated circuit to be stored digitally in the memory.

11. The system for a distributed memory panel of claim 8, wherein the memory is complementary metal-oxide-semiconductor digital storage elements.

12. The system for a distributed memory panel of claim 8, wherein the integrated circuit comprises:
a counter based digital circuit to convert received data into a pulse width modulation signal; and
wherein the driver is to drive the light emitter of the pixel based on the pulse width modulation signal.

13. The system for a distributed memory panel of claim 8, comprising:
a second light emitter of a second pixel on the panel; and
wherein the integrated circuit comprises:
an analog signal converter to receive analog signals from a driver integrated circuit for both the light emitter and the second light emitter and to convert the analog signals to digital signals to be stored digitally in the memory.

14. The system for a distributed memory panel of claim 8, comprising:
a second light emitter of a second pixel on the panel; and
wherein the integrated circuit comprises:
a digital signal receiver to receive signals from a driver integrated circuit for both the light emitter and the second light emitter to be stored digitally in the memory.

15. The system for a distributed memory panel of claim 8, wherein:
the frame buffer stores data for a frame to be displayed on the panel;
the timing controller reads the data for the frame from the frame buffer and sends the data for the frame to the driver integrated circuit;
the driver integrated circuit drives the data for the frame to the integrated circuit; and
at least one of the frame buffer, the timing controller, and the driver integrated circuit stop receiving power until the panel electronics unit receives an instruction to update the data for the frame being driven to the integrated circuit.

16. The system for a distributed memory panel of claim 8, wherein:
the frame buffer stores data for the light emitter to be displayed on the panel;
the timing controller reads the data for the light emitter from the frame buffer and sends the data for the light emitter to the driver integrated circuit;
the driver integrated circuit drives the data for the light emitter to the integrated circuit; and
at least one of the frame buffer, the timing controller, and the driver integrated circuit stop receiving power until the panel electronics unit receives an instruction to update the data for the light emitter being driven to the integrated circuit.

17. A method to implement a distributed memory panel comprising:
receiving a signal for a light emitter of a pixel with an integrated circuit on a panel;
storing the signal as data in a memory of the integrated circuit wherein the memory is exclusively associated with the light emitter;
driving the light emitter of the pixel with a driver of the integrated circuit based on the data.

18. The method of claim 17, wherein the integrated circuit comprises an analog signal converter to convert the signal, if the signal is analog, to a signal that is digital prior to storage as data in the memory.

19. The method of claim 17, wherein the memory is complementary metal-oxide-semiconductor digital storage elements.

20. The method of claim 17, wherein the integrated circuit comprises:
converting the signal received into data for pulse width modulation; and
wherein the driving of the light emitter is based on the data for pulse width modulation.
